(19) United States
(12) Patent Application Publication
(10) Pub. No.: US 2012/0168200 A1
(43) Pub. Date: Jul. 5, 2012

(54) METHOD FOR MANUFACTURING JOINT STRUCTURE OF STEEL SHEET AND ALUMINUM SHEET, AND JOINT STRUCTURE OF STEEL SHEET AND ALUMINUM SHEET MANUFACTURED BY THE METHOD

(75) Inventors: Masatoshi Iwai, Kakogawa-shi (JP); Shoji Hisano, Kakogawa-shi (JP); Takeshi Ohwaki, Kobe-shi (JP); Shinji Sakashita, Kobe-shi (JP); Kasumi Yanagisawa, Kobe-shi (JP); Akihiko Tatsumi, Kobe-shi (JP)

(73) Assignee: Kabushiki Kaisha Kobe Seiko Sho (Kobe Steel, Ltd.), Kobe-shi (JP)

(21) Appl. No.: 13/395,904

(22) PCT Filed: Dec. 3, 2010
(86) PCT No.: PCT/JP10/71686

§ 371 Date: Mar. 14, 2012

(30) Foreign Application Priority Data
Dec. 10, 2009 (JP) 2009-280890

(51) Int. Cl. H01B 5/00; H01R 4/04

(52) U.S. Cl. 174/126.1; 156/49

(57) ABSTRACT

A process for producing a joint structure of a steel sheet and an aluminum sheet, in which the steel sheet and the aluminum sheet are joined to each other so as to be electrically connected to each other. The process is characterized by comprising a step of forming at least one resin coating film in a thickness of 0.1 to 5.0 μm on a contact surface on the steel sheet side, wherein the resin is selected from the group consisting of a polyolefin resin, a polyurethane resin and an epoxy resin.

### TECHNICAL FIELD

The present invention relates to a method for manufacturing a joint structure of a steel sheet and an aluminum sheet, and to a joint structure of a steel sheet and an aluminum sheet manufactured by the method The joint structure includes a steel sheet and an aluminum sheet in contact in a face-to-face manner (planar junction) so as to be electrically connected to each other. The joint structure is used in areas typically of transportation equipment such as automobiles and railway vehicles; machinery; civil engineering, construction, and plants; and electronics.

### BACKGROUND ART

Typically in areas of transportation equipment such as automobiles and railway vehicles, needs have recently grown on members each including steel and aluminum (alloy) materials in combination, being lightweight, having a high strength, and also having resistance to collision.

In general, when steel and aluminum materials are used in combination typically in automobiles, a steel sheet and an aluminum sheet are joined to each other typically through resistance welding or mechanical joint. When a steel sheet and an aluminum sheet are joined in a butt manner, the resulting junction is resistant to gap formation, because the two sheets are in intimate contact with each other in the joint area. In contrast, when a steel sheet and an aluminum sheet are joined in a face-to-face manner (planar junction), the two sheets are not completely in intimate contact with each other in the joint area, and a gap at a varying spacing (distance) may be generated between the steel sheet and the aluminum sheet due to strain of the members themselves or strain caused typically by spot welding. The gap, if having a size (spacing between the steel sheet and the aluminum sheet) of about 0.1 mm or less, impedes the entry of a paint thereinto upon electropainting generally used in a primer coating process in manufacture of automobiles, and this causes unpainted portions on the surfaces of the steel and aluminum materials inside the gap.

If water migrates into the gap upon use typically of an automobile, bimetallic corrosion (galvanic corrosion) occurs between the unpainted portion in the steel sheet and that in the aluminum sheet, and this promotes the corrosion of aluminum which is baser than the steel. The galvanic corrosion is a phenomenon which occurs upon contact between dissimilar metals such as a steel and aluminum, in which a cell is formed with, of the dissimilar metals, a baser metal serving as an anode, a more noble metal serving as a cathode, through an electrolyte formed by the water migrated into the gap on the contact surface, and the cell promotes the corrosion of the baser metal. Specifically, upon usage, the joint structure of dissimilar metals of steel sheet/aluminum sheet, if having the gap, suffers from accelerated corrosion of aluminum at an extremely higher rate than that of aluminum alone, and this causes damage such as pitting corrosion in early stages. Members/parts formed by planar junction of dissimilar metals should therefore be prevented from such galvanic corrosion.

For the prevention of galvanic corrosion, electric insulation between dissimilar metals with the interposition of an insulating material is effective. This technique, however, not only is difficult to be performed in many cases due to limitations in structure and manufacture, but also impedes the application of welding which is superior in joint strength. For example, Patent Literature (PTL) 1 discloses a technique of previously applying an organic resin adhesive to a portion of dissimilar metals to be in contact, and performing spot welding. This technique, however, needs much time and efforts to be performed and may suffer corrosion generated from coating defects, because the coating may often be ununiform.

Independently, there has been proposed a technique of preparing a precoated steel sheet and a precoated aluminum sheet each coated with an organic resin previously, processing these precoated sheets into members, and assembling them through joining with an adhesive (e.g., PTL 2). This technique surely avoids contact corrosion, but needs much time and efforts to be performed because of using an adhesive for joining, fails to have reliability in bonding strength, and is unsuitable to be applied to structural members.

There has been also proposed a technique of interposing a Zn—Al—Mg alloy between an aluminum-based composite material and an iron/steel material so as to effectively prevent galvanic corrosion between the two materials (e.g., PTL 3). Even this technique, however, is complicated in process steps, because the Zn—Al—Mg alloy layer should be formed by means typically of plating.

Independently, there is known a technique for preventing corrosion of a metal material in which a small or trace amount of a corrosion inhibitor (also simply called “inhibitor”) is added to a corrosive environment to which the metal is to be exposed. Examples of generally known inhibitors include sulfites and hydrazines each working as an oxygen scavenger to remove oxygen necessary of the corrosion resistance and to thereby reduce corrosivity; calcium ion which forms a precipitated film of calcium carbonate on the metal surface to protect the metal surface; molybdates which passivate the iron surface and thereby contribute to suppressed corrosion; amines, aniline, and other adsorbed-film-forming inhibitors which have a polar group containing nitrogen (N), oxygen (O) or another element with a large electronegativity and allow the polar group to be adsorbed on the metal surface to develop a corrosion suppression action; benzotriazole, thioglycolic adds, and other precipitated-film-forming inhibitors which react with a metal ion generated through dissolution of the metal, thereby form a stable chelate compound on the surface to thereby develop a corrosion suppression action; and carboxylic acids which form an oxide film on the metal surface (Non Patent literature (NPL) 1).

Based on the findings about such inhibitors, PTL 4 describes a technique of preventing galvanic corrosion by using a composition containing a nitrous acid inhibitor or an oxyanion inhibitor. However, these inhibitors are not applicable to suppression of contact corrosion between a steel and a metal (e.g., aluminum) having a potential baser than that of the steel, although they are effective for suppression of contact corrosion between a steel and a stainless steel having a potential more noble than that of the steel, or between titanium and a regular steel.

PTL 1: Japanese Unexamined Patent Application Publication (JP-A) No. 2008-80394

PTL 2: Japanese Unexamined Patent Application Publication (JP-A) No. H05-50173

PTL 3: Japanese Unexamined Patent Application Publication (JP-A) No. 2001-11665

PTL 4: Japanese Unexamined Patent Application Publication (JP-A) No. H04-160169

NPL 1: Corrosion Handbook, edited by Japan Society of Corrosion Engineering, pp. 641-679 (1992)

### DISCLOSURE OF INVENTION

### Technical Problem

In consideration of the customary techniques, an object of the present invention is to provide a method for manufacturing a joint structure of a steel sheet and an aluminum sheet, which effectively suppresses contact corrosion in a contact surface between the steel and the aluminum materials. Another object of the present invention is to provide a joint structure of a steel sheet and an aluminum sheet which is manufactured by the manufacturing method and is satisfactorily resistant to contact corrosion.

### Solution to Problem

The present invention has achieved the objects and provides a method for manufacturing a joint structure of a steel sheet and an aluminum sheet, the steel sheet and the aluminum sheet being joined to each other so as to be electrically connected to each other. The method includes the step of forming a resin film to a thickness of from 0.1 to 5.0 μm at least on a joint surface of the steel sheet, the resin film including at least one resin selected from the group consisting of polyolefin resins, polyurethane resins, and epoxy resins.

In a preferred embodiment of the present invention, the resin film contains a silica in a content of from 5 to 80 percent by mass. In another preferred embodiment, the resin film contains at least one inhibitor selected from the group consisting of benzoic acid salts, glutamic acid salts, anisidine, glycine, quinolinols, phthalic acid salts, adipic acid salts, and acetic acid salts, in a total content of 0.1 to 20 percent by mass. These preferred embodiments give a joint structure of a steel sheet and an aluminum sheet having further better contact corrosion resistance. The steel sheet is preferably a zinc-plated steel sheet.

The resin film is preferably formed by wringing with a wringer roll or coating with a roll coater. After the formation of the resin film, the steel sheet and the aluminum sheet are preferably joined by resistance spot welding, thus being efficient.

The present invention further provides a joint structure of a steel sheet and an aluminum sheet, manufactured by the manufacturing method.

### Advantageous Effects of Invention

The manufacturing method according to the present invention provides a joint structure of a steel sheet and an aluminum sheet excellent in contact corrosion resistance.

### BRIEF DESCRIPTION OF DRAWINGS

FIG. 1 is a schematic plan view illustrating a joint structure specimen.

FIG. 2 is a schematic plan view illustrating a specimen for contact corrosion simulation test.

FIG. 3 is a schematic cross-sectional view illustrating the specimen for contact corrosion simulation test.

### REFERENCE SIGNS LIST

1, 1′: steel sheet

2, 2′: aluminum sheet

3: joint point

4: clip

5: electroconductive tape

6: spacer

7: seal

10: joint structure specimen

20: specimen for contact corrosion simulation test

### BEST MODES FOR CARRYING OUT THE INVENTION

A manufacturing method according to an embodiment of the present invention is a method for manufacturing a joint structure of a steel sheet and an aluminum sheet, the steel sheet and the aluminum sheet being joined to each other so as to be electrically connected to each other, which method includes the step of forming a resin film to a thickness of from 0.1 to 5.0μm at least on a surface of the steel sheet facing the aluminum sheet, the resin film including at least one resin selected from the group consisting of polyolefin resins, polyurethane resins, and epoxy resins. As used herein the term “aluminum sheet” also includes an aluminum alloy sheet.

The manufacturing method according to the present invention should provide a joint structure in which a steel sheet and an aluminum sheet are joined so as to be electrically connected to each other. This allows welding to be applied to the manufacture of the joint structure, which welding provides a reliable bonding strength In contrast, a structure having electric insulation between the steel sheet and the aluminum sheet is often difficult to be provided, because of limitations in structure and manufacturing, and welding is not applicable to the manufacture of this structure, as mentioned above.

To achieve the objects, the present inventors made investigations and found that contact corrosion can be effectively inhibited by forming a resin film on, of joint surfaces of the steel sheet and the aluminum sheet, at least on the surface of the steel sheet facing the aluminum sheet (the surface is hereinafter also simply referred to as “joint surface”). The present invention has been made based on these findings. Specifically, as a result of investigations, the present inventors found that a resin film, when formed on the joint surface of the steel sheet, effectively suppresses contact corrosion of the aluminum sheet which is baser in potential; and that the resin film, when further formed on the joint surface of the aluminum sheet in addition to that of the steel sheet, allows the aluminum sheet to have further improved contact corrosion resistance. The present inventors, however, further found that a resin film, if formed on the joint surface of the aluminum sheet alone, fails to suppress contact corrosion of the aluminum sheet. This is probably because as follows.

Specifically, such a thin resin film as to allow welding should be formed according to the present invention, but the resulting resin film may suffer pinholes because of such a small thickness. If the joint surface of the aluminum sheet alone, which is baser in potential than the steel sheet, is covered with a resin film, a corrosion current passing between the steel sheet and the aluminum sheet is reduced in its absolute value, but the corrosion current focuses on the pinhole area in the resin film and erodes only aluminum in the pinhole area. As a result, the aluminum sheet is eroded to a depth equivalent to that in an aluminum sheet without a resin film, thus the contact corrosion proceeds.

In contrast, when a resin film is formed on the joint surface of the steel sheet, the corrosion current is reduced in its absolute value, current focusing to the surface of the aluminum sheet is avoided, and this surely reduces the depth of erosion of the aluminum sheet. When the resin film is further formed on the joint surface of the aluminum sheet in addition to that of the steel sheet, the corrosion current is further reduced in its absolute value, the current focusing to the surface of the aluminum sheet is further avoided, and this further reduces the depth of erosion of the aluminum sheet as compared to the case where the resin film is formed only on the contact surface of the steel sheet.

For these reasons, the resin film is formed at least on the joint surface of the steel sheet according to the present invention. The resin film is preferably formed also on the joint surface of the aluminum sheet, in addition to that of the steel sheet.

The resin film should have a thickness of 0.1 μm to 5.0 μm. The resin film, when having a thickness within this range, helps to give a joint structure of a steel sheet and an aluminum sheet excellent in contact corrosion resistance. A resin film having a thickness of less than 0.1 μm may not cover the surface of the steel sheet sufficiently and may not exhibit the suppressing effect on the contact corrosion of the aluminum sheet. A resin film having a thickness of more than 5.0 μm may substantially impede resistance spot welding, thus being undesirable. The resin film more preferably has a thickness of 0.3 μm or more and 2.0 μm or less. When resin films are formed both on the steel sheet and the aluminum sheet, the term “thickness” refers to the total thickness of the two resin films.

For improving contact corrosion resistance, the resin film is formed at least on a joint surface, in the steel sheet (and in the aluminum sheet). The resin film, however, may be formed on (applied to) both sides of the sheet(s), when coating on both sides of the sheet(s) is efficient in consideration of manufacturing procedure.

A resin for constituting the resin film may be chosen from polyolefins, polyurethanes, and epoxy resins from the viewpoints of contact corrosion resistance and conformity to electropainting. The resin may be a mixture of two or more different types of these resins. The resin component is contained in the resin film preferably in a content of from 20 percent by mass to 100 percent by mass. The resin component, if contained in an excessively low content, may not suppress the generation of pinholes in the resin film and, when a silica is incorporated in the resin film, may fail to prevent the silica from dropping off.

The present invention is advantageously applied to the manufacture of a structure in which a steel sheet and an aluminum sheet are in surface contact (face-to-face contact) with each other with the interposition of a resin film. As is described above, a structure including a steel sheet and an aluminum sheet being joined to each other in a butt manner is resistant to contact corrosion, because the two sheets are in intimate contact with each other in the joint area, are thereby resistant to gap formation, and, when the butt portion is painted, water invasion can be prevented. Accordingly, when the present invention is applied to the structure just mentioned above, the contact corrosion suppression effect is not outstanding. In contrast, when a steel sheet and an aluminum sheet are overlaid and joined with each other, the contact surface has a large area, and a gap is formed between the steel sheet and the aluminum sheet to often cause contact corrosion of the resulting structure, as is described above. For these reasons, the present invention is significantly technically advantageously applied to the structure of this kind so as to suppress contact corrosion.

The resin film for use in the present invention may further contain a silica Though not critical, the content of silica is preferably 5 percent by mass or more and more preferably 20 percent by mass or more, and is preferably 80 percent by mass or less and more preferably 70 percent by mass or less, based on the total mass (100 percent by mass) of the resin film. Silica, when contained in a content within the above-specified range, allows the resin film to have a satisfactory strength and good scratch resistance to thereby have further improved contact corrosion resistance. In contrast, silica, if contained in a content of less than 5 percent by mass, may not exhibit the effect of improving scratch resistance and contact corrosion resistance. Silica, if contained in a content of more than 80 percent by mass, may impair film formability, and this may tend to cause the resin film to be powdery and to have insufficient contact corrosion resistance, thus being undesirable.

The silica is not limited in type and may be chosen from dry silica and colloidal silica. The silica is preferably dry silica when a coating composition for the formation of the resin film is a solvent-borne composition; whereas the silica is preferably colloidal silica when the coating composition is an aqueous one.

The present inventors made a search for inhibitors which act upon the contact corrosion area between a steel sheet and an aluminum sheet so as to exhibit the function of suppressing contact corrosion of aluminum to further improve the contact corrosion resistance of a joint structure of steel sheet/aluminum sheet. As a result, they found as follows.

Specifically, the present inventors found that the known inhibitors for inhibiting corrosion of metal materials, if contained in the resin film for use in the present invention, fail to effectively suppress the contact corrosion. The known inhibitors include sulfites, hydrazines, calcium ion, molybdates, amines, aniline, benzotriazole, thioglycolic acids, and carboxylic acids, as described in “Background Art”. The present inventors further found that the resin film, when containing at least one inhibitor selected from the group consisting of benzoic acid salts, glutamic acid salts, anisidine, glycine, quinolinols, phthalic acid salts, adipic acid salts, and acetic acid salts, further improves the contact corrosion resistance of aluminum.

The reason why benzoic add salts, glutamic add salts, anisidine, glycine, quinolinols, phthalic acid salts, adipic acid salts, or acetic acid salts improve the contact corrosion resistance is probably as follows. These inhibitors grads sally dissolve from the film into the corrosive environment and are adsorbed by the surfaces of the steel sheet and the aluminum sheet to reduce the corrosion rates of the steel sheet and the aluminum sheet and, in addition, to reduce the difference in potential between the steel sheet and the aluminum sheet. Probably based on these effects, the inhibitors reduce the contact corrosion of the joint structure of steel sheet/aluminum sheet. An invention relating to the effects of these inhibitors to improve the contact corrosion has been applied for patent by the applicant of the present application as Japanese Patent Application No. 2009-094739.

Potassium salts, sodium salts, and ammonium salts are preferred as the benzoic acid salts, glutamic acid salts, phthalic acid salts, adipic acid salts, and acetic acid salts. The inhibitor may be a mixture of two or more of different salts of them. When the coating composition for the formation of the resin film is an aqueous one, these salts are preferably used because they are highly soluble in water and are thereby present uniformly in the resin film to exhibit the effect of suppressing the contact corrosion uniformly over the entire resin film.

The inhibitor is preferably contained in the film in a content of from 0.1 to 20 percent by mass. The inhibitor, when contained in a content within the above-specified range, may further improve the contact corrosion resistance of the joint structure of steel sheet/aluminum sheet. In contrast, the inhibitor, if in a content of less than 0.1 percent by mass, may not sufficiently effectively improve the contact corrosion resistance. The inhibitor, if in a content of more than 20 percent by mass, may tend to cause the effect of improving the contact corrosion resistance to be saturated, thus economically ineffective. Each of different inhibitors may be used alone or in combination.

The step of forming the resin film may be performed at any timing before the steel sheet and the aluminum sheet are joined. The formation of the resin film preferably employs a coating composition for the formation of the resin film. The coating composition may be prepared typically as an organic solvent solution, an aqueous solution, or an aqueous dispersion, according to the type of the resin. Such a resin is commercially available in the form of an organic solvent solution, an aqueous solution, or an aqueous dispersion, and the commercial product may be used as intact, or as diluted or concentrated, as the coating composition. To incorporate the silica and/or inhibitor into the resin film, the coating composition may be prepared by adding the silica and/or inhibitor to other components constituting the mating composition, followed by thoroughly mixing them. Where necessary, the coating composition may further contain any of additives. Exemplary additives include additives for improving lubricity of the film, such as molybdenum disulfide and wax particles; silane coupling agents; crosslinking agents; and surfactants.

To form the resin film uniformly and economically, it is recommended that the resin film is formed continuously on a coil of the steel sheet and/or aluminum sheet. Specifically, in a preferred embodiment of the method, the coating composition for the formation of the resin film is continuously applied to the steel sheet alone, or to the steel sheet and the aluminum sheet typically through wringing with a groove roll as a wringer roll or coating with a roll coater, and the resulting coating is baked and dried. This process is performed in a continuous painting line, or an aftertreatment section of electro-galvanizing line, or hot-dip galvanizing line. Such a uniformly formed resin film can reduce the risk of such defects due to non-uniform coating as to generate corrosion and thereby give a joint structure of steel sheet/aluminum sheet having highly reliable contact corrosion resistance. The duration and temperature of baking/drying may be determined suitably according to the resin to be used The resin film may be formed on both sides of the steel sheet, or both sides of the steel sheet and of the aluminum sheet, as mentioned above.

The resin film, when formed directly on the surface of the steel sheet without the interposition of a plated layer, may give a joint structure having satisfactory contact corrosion resistance. The steel sheet, however, is preferably a zinc-plated steel sheet which is a steel sheet with a zinc-based plating, such as electro-galvanized steel sheet, Zn—Ni alloy electroplated steel sheet, hot-dip galvanized steel sheet, galvannealed steel sheet, Zn-5% Al plated steel sheet, or 55% Al—Zn plated steel sheet. This is because the zinc-based plated layer has the function of further suppressing the contact corrosion between the steel sheet and the aluminum sheet. The steel sheet may be suitably chosen from among, for example, mild steel sheets and high-tensile steel sheets.

Exemplary aluminum sheets for use herein include pure aluminum sheets, Al—Mn alloy sheets, Al—Mg alloy sheets, Al—Zn—Mg alloy sheets, and Al—Si alloy sheets.

Though the resin film has the functions of primary rust prevention during storage before joining and of reduction in frictional coefficient upon pressing (stamping), it is preferred to further apply a rust preventive oil to the steel sheet so as to further improve the primary rust prevention function during storage and the sliding properties upon stamping.

The resin-film-laminated steel sheet manufactured by the method mentioned above, and the aluminum sheet or the resin-film-laminated aluminum sheet are subjected to cutting and/or stamping into members (parts), and are joined so that two sheets face each other, and thereby yield a joint structure.

Examples of joining technique usable herein include, but are not limited to, partial joining procedures including resistance spot welding (RSW); riveting such as self piercing riveting (SPR); friction bonding, bolting and caulking. Independently, line welding such as laser welding or metal inert gas are welding (MIG welding) is advantageously used typically in the case where the structure includes many gaps between the steel sheet and the aluminum sheet. Among these techniques, resistance spot welding is recommended because this technique is easily automated, is performed within a short period of time, and is suitable for mass production.

The structure after joining is generally subjected to chemical conversion treatment, electropainting, and finish painting. Examples of the chemical conversion treatment include known surface preparations such as phosphatization, chromate treatment, chromate-free surface preparation, and silane coupling treatment.

The joint structure of steel sheet/aluminum sheet according to the present invention manufactured by the method of the present invention is a high-performance structure usable as a member which has both a light weight and a high strength, exhibits good collision resistance, and excels in contact corrosion resistance.

### EXAMPLES

The present invention will be illustrated in further detail with reference to several working examples below. It should be noted, however, that these examples are never construed to limit the scope of the present invention, and alternations and changes as appropriate are possible within the spirit and scope of the present invention, and they are all fall in the technical scope of the present invention. All parts and percentages are by mass, unless otherwise specified.

### <Preparation of Joint Structure Specimen>

In Examples 1 to 17 and Comparative Examples 8 and 9, a resin film was formed on a steel sheet in the following manner. A steel sheet (40 mm wide, 110 mm long, and 1.0 mm thick, of the type given in Table 1) was immersed in a coating composition for the formation of film, wrung with a groove roll to remove excess coating composition, dried in a conveyor drying furnace at a furnace temperature of 220° C. for 12 seconds, and thereby yielded a resin film on the steel sheet. The thickness of the resin film was controlled by the pressure of wringing by the groove roll and the concentration of coating composition. The composition of the coating composition and the thickness of the resin film are indicated in Tables 2 and 3. In Comparative Examples 1 to 7, no resin film was formed on the steel sheet (Table 3).

A polyolefin film 0.7 μm thick was formed on the surface of an aluminum sheet (6000-series aluminum alloy sheet, 70 mm wide, 150 mm long, and 1.0 mm thick) by the above procedure.

The steel sheet and the aluminum sheet were joined through resistance spot welding (RSW) or self piercing riveting (SPR) and thereby yielded a joint structure specimen. The aluminum sheet bearing the polyolefin film was used in Example 15 and Comparative Examples 6 and 7, whereas, the aluminum sheet not bearing the film was used in Examples 1 to 14, 16, and 17 and Comparative Example 1 to 5, 8, and 9.

The resistance spot welding (RSW) was performed at an applied pressure of 3.5 kN and a current of 26 KAm for a welding time per one spot of 120 ms. The self piercing riveting (SPR) was performed at a caulking pressure of 150 bar (15 MPa).

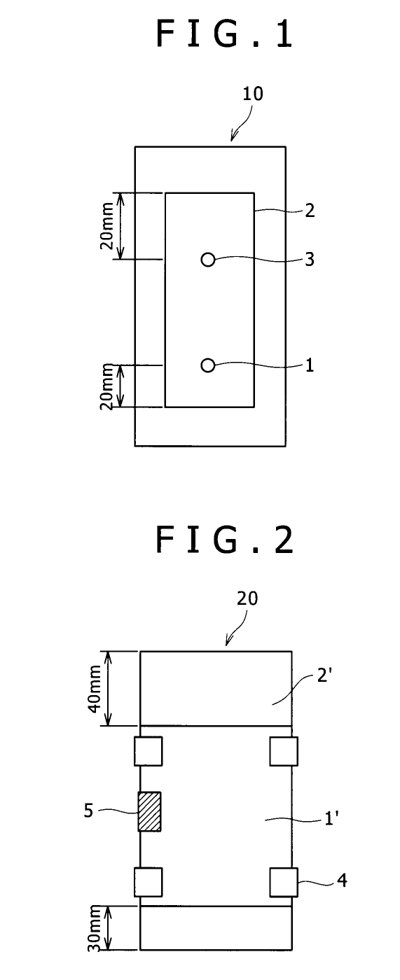

FIG. 1 is a schematic plan view illustrating the joint structure specimen. In the joint structure specimen 10, the steel sheet 1 positioned in the central area of the aluminum sheet 2 is joined with the aluminum sheet 2 at (two) joint points 3 through RSW or SPR

The joint structure specimen underwent phosphatization and electropainting and was subjected to a corrosion test. The phosphatization and electropainting were performed under the following conditions.

Phosphatization
Treatment liquid: “PBL-3027” (supplied by Nihon Parkerizing Co., Ltd.)
Temperature: 40° C., Time: 2 minutes

The phosphatization was performed under such conditions that the mass of coating be about 2.0 g/m² in the cold-rolled mild steel sheet, and be about 1.8 g/m² in the aluminum sheet (6000-series aluminum alloy sheet).

Electropainting
Cationic electrodeposition paint: “PN310” (supplied by NIPPON PAINT Co, Ltd.)
Temperature: 30° C., Voltage: 200 V, Time: 3 minutes, Baking 160° C. for 20 minutes, Thickness of coating: 20 μm (outer side of specimen)

Part of the joint structure specimen was disassembled before the corrosion test, and the inside of the joint was observed to find that the electrodeposition paint was deposited partially, with a thickness of coating in the deposited area of from about 2 μm to about 7 μm.

### <Preparation of Specimen for Contact Corrosion Simulation Test>

A resin film was formed on a steel sheet (70 mm wide, 80 mm long, and 1.0 mm thick, of the type given in Table 1) by the procedure described in the <Preparation of Joint Structure Specimen>. The chemical composition of the coating composition and the thickness of the resin film are indicated in Table 4 to 6. In Comparative Example 10, no film was formed on the steel sheet (fable 6).

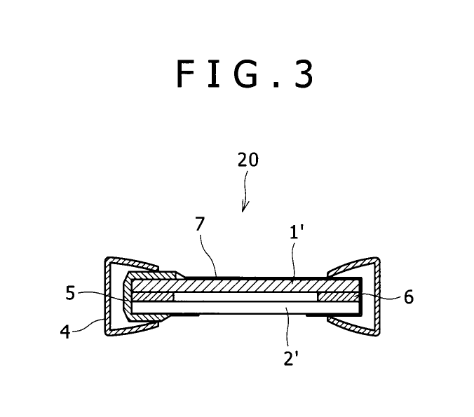

A specimen for contact corrosion simulation test was prepared using the above-prepared steel sheet and an aluminum sheet (6000-series aluminum alloy, 70 mm wide, 150 mm long, and 1.2 mm thick) bearing no resin film. FIGS. 2 and 3 are a schematic plan view and a schematic cross-sectional view, respectively, illustrating the specimen for contact corrosion simulation test. In the specimen 20 for contact corrosion simulation test, the spacing between the aluminum sheet 2′ and the steel sheet 1′ positioned approximately in the central area of the aluminum sheet 2′ was set constant at 0.1 mm by the action of a spacer 6 (shown in FIG. 3 alone) made from a polytetrafluoroethylene sheet, for precise evaluation of contact corrosion. The steel sheet 1′ and the aluminum sheet 2′ were fixed by clips 4 (at four points). A joint structure of steel sheet/aluminum sheet joined through RSW or SPR suffers ununiform spacing between the steel sheet and the aluminum sheet because of strain generated in the steel sheet and the aluminum sheet. To avoid such ununiform spacing in the specimen 20 for contact corrosion simulation test, the continuity (conduction) between the steel sheet 1′ and the aluminum sheet 2′ was ensured by the action of an electroconductive tape 5 (Model Number 1170,10 mm wide, 80 mm long, and 0.1 mm thick, supplied by Sumitomo 3M Limited). In addition, a seal 7 (indicated in FIG. 3 alone) was applied to the outer surface of the steel sheet 1′. The specimen for contact corrosion simulation test did not undergo chemical conversion treatment and electropainting.

The resin and other additives used in the examples according to the present invention and the comparative examples are as follows.

Polyolefin resin (High-Tech (registered trademark) S-3121, aqueous, supplied by TOHO Chemical Industry Co, Ltd)

Polyurethane resin (UREARNO (registered trademark) W500, aqueous, supplied by Arakawa Chemical Industries, Ltd)

Epoxy resin (EM-1-60L, supplied by ADEKA CORPORATION)

Poly(vinyl butyral) resin (average degree of polymerization: 630, supplied by Wako Pure Chemical Industries, Ltd)

Polyacrylic acid resin (average molecular weight: 25000, supplied by Wako Pure Chemical Industries, Ltd)

Silica: colloidal silica (Snowtex (registered trademark) XS, supplied by NISSAN CHEMICAL INDUSTRIES, LTD)

Sodium L-glutamate (reagent supplied by Wako Pure Chemical Industries, Ltd.)

Sodium benzoate (reagent supplied by Wako Pure Chemical Industries, Ltd.)

Ammonium benzoate (reagent supplied by Wako Pure Chemical Industries, Ltd.)

Anisidine (reagent supplied by Wako Pure Chemical Industries, Ltd.)

Quinolinols (reagent supplied by Wako Pure Chemical Industries, Ltd.)

Glycine (reagent supplied by PEPTIDE INSTITUTE, INC)

Ammonium phthalate (reagent supplied by Wako Pure Chemical Industries, Ltd.)

Potassium phthalate (reagent supplied by Wako Pure Chemical Industries, Ltd.)

Ammonium adipate (reagent supplied by Wako Pure Chemical Industries, Ltd.)

Sodium acetate (reagent supplied by Wako Pure Chemical Industries, Ltd.)

### <Corrosion Simulation Test>

The joint structure specimen or the specimen for contact corrosion simulation test was subjected to 30 cycles (8 hours per cycle) of a combined cyclic corrosion test (neutral salt spray cyclic test prescribed in JIS H 8502) as a corrosion test. The specimen after the corrosion test was disassembled, from which the coating and corrosion products were removed, and the erosion depth due to corrosion was measured on the steel sheet and the aluminum sheet. In the case of the specimen for contact corrosion simulation test, removal of coating was not performed, because the specimen did not undergo electropainting.

Removals of coating and corrosion products were performed under the following conditions.

Removal of Coating
Immersion in a coating remover (CS500, supplied by NEOS COMPANY LIMITED) at 60° C. for 30 minutes

Removal of Corrosion Products on the Steel Sheet
Immersion in a 10% ammonium citrate solution at 70° C. for 30 minutes

Removal of Corrosion Products on the Aluminum Sheet
Immersion in 30% nitric acid at 60° C. for 10 minutes

Measurement of the erosion depth was performed using a dial gauge with a sharp tip. For the joint structure specimen, the erasion depth was measured as a maximum erosion depth in an area 30 mm wide and 100 mm long. This area corresponds to the portion (40 mm wide and 110 mm long) where the steel sheet and the aluminum sheet were laid on each other, except for excluding the rim of 5 mm. For the specimen for contact corrosion simulation test, the erosion depth was measured as a maximum erosion depth in an area where the steel sheet and the aluminum sheet were laid on each other. The corrosion test was repeated on three specimens per each sample (n=3), and the average of the three maximum erosion depths was defined as the erasion depth. The results are indicated in Tables 2 to 6.

TABLE 1

| | | | Mass of coating |
|---|---|---|---|
| Type of steel | | Plating layer | (per one side) |
| sheet | Base steel | (plating on both sides) | (g/m²) |
| Cold-rolled | 60K class | none | — |
| | high-tensile | | |
| | steel sheet | | |
| GA | Mild steel | Hot-Dip galvannealed | 47 |
| | | layer (Fe: 11%) | |
| GI | Mild steel | Hot-dip galvanized layer | 65 |
| EG | Mild steel | Electrogalvanized layer | 57 |
| Zn—Ni | Mild steel | Zn—12% Ni alloy | 20 |
| | | electroplated layer | |
| Zn—5%Al | Mild steel | Zn—4.5%Al alloy hot | 63 |
| | | dipped layer | |

TABLE 2

| | | Composition of film on steel sheet | | | Film | Film on | | Erosion depth (mm) | |
|---|---|---|---|---|---|---|---|---|---|
| | Steel | | Silica (percent | Other additive | thickness | aluminum | Joining | Steel | Aluminum |
| Example | sheet | Resin | by mass) | (percent by mass) | (μm) | sheet | process | sheet | sheet |
| Example 1 | Cold-rolled | Polyolefin | — | — | 0.6 | Absent | RSW | 0 | 0.10 |
| Example 2 | GA | Polyolefin | 30 | — | 0.6 | Absent | RSW | 0 | 0.05 |
| Example 3 | GA | Polyolefin | — | — | 0.6 | Absent | RSW | 0 | 0.06 |
| Example 4 | GI | Polyolefin | 30 | — | 0.6 | Absent | SPR | 0 | 0.05 |
| Example 5 | EG | Polyolefin | — | — | 0.6 | Absent | SPR | 0 | 0.07 |
| Example 6 | Zn—Ni | Polyolefin | — | — | 0.6 | Absent | RSW | 0 | 0.06 |
| Example 7 | Zn—5%Al | Polyolefin | 30 | — | 0.6 | Absent | SPR | 0 | 0.05 |
| Example 8 | GA | Epoxy | 20 | — | 0.6 | Absent | RSW | 0 | 0.07 |
| Example 9 | GA | Polyurethane | 20 | — | 0.5 | Absent | RSW | 0 | 0.06 |
| Example 10 | GA | Polyolefin | — | — | 0.5 | Absent | RSW | 0 | 0.06 |
| Example 11 | GA | Polyolefin | 30 | — | 0.5 | Absent | RSW | 0 | 0.04 |
| Example 12 | GA | Polyolefin | 30 | — | 1.5 | Absent | RSW | 0 | 0.04 |
| Example 13 | GA | Polyolefin | 30 | — | 4.3 | Absent | RSW | 0 | 0.04 |
| Example 14 | GA | Polyolefin | 30 | Sodium L-glutamate (2%) | 0.5 | Absent | RSW | 0 | 0.02 |
| Example 15 | GA | Polyolefin | 30 | — | 0.5 | Present | RSW | 0 | 0.01 |
| Example 16 | GA | Polyolefin | 30 | Ammonium phthalate (5%) | 0.6 | Absent | RSW | 0 | 0.01 |
| Example 17 | GA | Polyurethane | 40 | Ammonium phthalate (1%) | 0.6 | Absent | RSW | 0 | 0.03 |

TABLE 3

| | | Composition of film on steel sheet | | | Film | Film on | | Erosion depth (mm) | |
|---|---|---|---|---|---|---|---|---|---|
| Comparative | Steel | | Silica (percent | Other additive | thickness | aluminum | Joining | Steel | Aluminum |
| Example | sheet | Resin | by mass) | (percent by mass) | (μm) | sheet | process | sheet | sheet |
| Com. Ex. 1 | Cold-rolled | — | — | — | 0 | Absent | RSW | 0 | 0.31 |
| Com. Ex. 2 | GA | — | — | — | 0 | Absent | RSW | 0 | 0.20 |
| Com. Ex. 3 | Zn—Ni | — | — | — | 0 | Absent | RSW | 0 | 0.25 |
| Com. Ex. 4 | GI | — | — | — | 0 | Absent | RSW | 0 | 0.17 |
| Com. Ex. 5 | EG | — | — | — | 0 | Absent | RSW | 0 | 0.21 |
| Com. Ex. 6 | Cold-rolled | — | — | — | 0 | Present | RSW | 0.02 | 0.27 |
| Com. Ex. 7 | GA | — | — | — | 0 | Present | RSW | 0 | 0.23 |
| Com. Ex. 8 | GA | Polyolefin | 30 | — | 0.05 | Absent | RSW | 0 | 0.21 |
| Com. Ex. 9 | GA | Polyolefin | 30 | — | 6.0 | Absent | RSW | Untestable | Untestable |

TABLE 4

| | | Composition of film on steel sheet | | | Film | Erosion depth (mm) | |
|---|---|---|---|---|---|---|---|
| | Steel | | Silica (percent | Other additive | thickness | Steel | Aluminum |
| Example | sheet | Resin | by mass) | (percent by mass) | (μm) | sheet | sheet |
| Example 18 | GA | Polyolefin | — | — | 0.6 | 0 | 0.07 |
| Example 19 | GA | Epoxy | — | — | 0.6 | 0 | 0.10 |
| Example 20 | GA | Polyurethane | 40 | — | 0.6 | 0 | 0.08 |
| Example 21 | GA | Polyolefin | 2 | — | 0.6 | 0 | 0.07 |
| Example 22 | GA | Polyolefin | 10 | — | 0.6 | 0 | 0.05 |
| Example 23 | GA | Polyolefin | 30 | — | 0.6 | 0 | 0.05 |
| Example 24 | GA | Polyolefin | 50 | — | 0.6 | 0 | 0.04 |
| Example 25 | GA | Polyolefin | 70 | — | 0.6 | 0 | 0.06 |
| Example 26 | GA | Polyolefin | 90 | — | 0.6 | 0 | 0.10 |
| Example 27 | GA | Polyolefin | 30 | — | 0.1 | 0 | 0.12 |
| Example 28 | GA | Polyolefin | 30 | — | 0.3 | 0 | 0.08 |
| Example 29 | GA | Polyolefin | 30 | — | 1.0 | 0 | 0.04 |
| Example 30 | GA | Polyolefin | 30 | — | 2.1 | 0 | 0.04 |
| Example 31 | GA | Polyolefin | 30 | — | 4.4 | 0 | 0.04 |

TABLE 5

| | | Composition of film on steel sheet | | | Film | Erosion depth (mm) | |
|---|---|---|---|---|---|---|---|
| | Steel | | Silica (percent | Other additive | thickness | Steel | Aluminum |
| Example | sheet | Resin | by mass) | (percent by mass) | (μm) | sheet | sheet |
| Example 32 | GA | Polyolefin | 30 | Sodium benzoate (0.05%) | 0.6 | 0 | 0.05 |
| Example 33 | GA | Polyolefin | 30 | Sodium benzoate (0.1%) | 0.6 | 0 | 0.04 |
| Example 34 | GA | Polyolefin | 30 | Sodium benzoate (0.5%) | 0.6 | 0 | 0.01 |
| Example 35 | GA | Polyolefin | 30 | Sodium benzoate (2%) | 0.6 | 0 | 0.01 |
| Example 36 | GA | Polyolefin | 30 | Sodium benzoate (10%) | 0.6 | 0 | 0.01 |
| Example 37 | GA | Polyolefin | 30 | Sodium benzoate (30%) | 0.6 | 0 | 0.01 |
| Example 38 | GA | Polyolefin | 30 | Ammonium benzoate (2%) | 0.6 | 0 | 0.01 |
| Example 39 | GA | Polyolefin | 30 | Sodium L-glutamate (1%) | 0.6 | 0 | 0.02 |
| Example 40 | GA | Polyolefin | 30 | Sodium L-glutamate (5%) | 0.6 | 0 | 0.01 |
| Example 41 | GA | Polyolefin | 30 | Anisidine (2%) | 0.6 | 0 | 0.02 |
| Example 42 | GA | Polyolefin | 30 | Quinolinol (2%) | 0.6 | 0 | 0.02 |
| Example 43 | GA | Polyolefin | 30 | Glycine (5%) | 0.6 | 0 | 0.02 |
| Example 44 | GA | Polyolefin | 30 | Ammonium phthalate (0.1%) | 0.6 | 0 | 0.03 |
| Example 45 | GA | Polyolefin | 30 | Ammonium phthalate (1%) | 0.6 | 0 | 0.01 |
| Example 46 | GA | Polyolefin | 30 | Ammonium phthalate (5%) | 0.6 | 0 | 0.01 |
| Example 47 | GA | Polyolefin | 30 | Potassium phthalate (1%) | 0.6 | 0 | 0.01 |
| Example 48 | GA | Polyolefin | 30 | Ammonium adipate (5%) | 0.6 | 0 | 0.02 |
| Example 49 | GA | Polyolefin | 30 | Sodium acetate (2%) | 0.6 | 0 | 0.03 |
| Example 50 | GA | Polyurethane | 40 | Ammonium phthalate (1%) | 0.6 | 0 | 0.03 |
| Example 51 | GA | Polyurethane | 40 | Potassium phthalate (1%) | 0.6 | 0 | 0.02 |

TABLE 6

| | | Composition of film on steel sheet | | | Film | Erosion depth (mm) | |
|---|---|---|---|---|---|---|---|
| Comparative | Steel | | Silica (percent | Other additive | thickness | Steel | Aluminum |
| Example | sheet | Resin | by mass) | (percent by mass) | (μm) | sheet | sheet |
| Com. Ex. 10 | GA | — | — | — | 0 | 0 | 0.18 |
| Com. Ex. 11 | GA | Polyolefin | 30 | — | 0.05 | 0 | 0.17 |
| Com. Ex. 12 | GA | Poly vinyl butyral | — | — | 1.5 | 0 | 0.17 |
| Com. Ex. 13 | GA | Poly acrylic acid | — | — | 1.8 | 0 | 0.18 |

The results in Table 2 demonstrate that the joint structure specimens in Examples 1 to 17 each using the steel sheet bearing the resin film having a thickness of from 0.1 to 5.0 μm have an maximum erosion depth in the aluminum sheet of 0.10 mm or less and do not substantially suffer corrosion. A comparison between the specimen of Example 11 and the specimen of Example 15 indicates that the resin film, when formed on the aluminum sheet in addition to the steel sheet, allows the joint structure to have further improved contact corrosion resistance.

In contrast, Table 3 demonstrates that the joint structure specimens in Comparative Examples 1 to 7 each using the steel sheet bearing no resin film suffer corrosion in the aluminum sheet in terms of maximum erosion depth of from 0.17 to 0.31 mm. The joint structure specimen in Comparative Example 8 does not enjoy effective corrosion suppression of the resin film even being formed on the steel sheet, because the resin film has an excessively small thickness (0.05 μm) and this causes the specimen to have a maximum erosion depth in the aluminum sheet of 0.21 mm. The joint structure specimen in Comparative Example 9 is impossible to undergo the test, because joining between the steel sheet and the aluminum sheet through resistance spot welding is impossible because of excessively large thickness (6.0 μm) of the resin film formed on the steel sheet. The joint structure specimens in Comparative Examples 6 and 7 having the resin film formed only on the aluminum sheet suffer corrosion in the aluminum sheet in terms of maximum erosion depth of from 0.23 to 0.27 mm and do not enjoy effective corrosion suppression

The results in Tables 4 and 5 indicate that the specimens for contact corrosion simulation test in Examples 18 to 51 each using the steel sheet bearing the resin film having a thickness of from 0.1 to 5.0 μm each have a maximum erosion depth in the aluminum sheet of 0.12 mm or less. The data in Examples 18 and 21 to 26 indicate that silica, when contained in the resin film in a content of from 5 to 80 percent by mass, helps to further suppress the contact corrosion of the aluminum sheet. Comparisons between the specimen in Example 23 and the specimens in Examples 32 to 49, and between the specimen in Example 20 and the specimens in Examples 50 and 51 demonstrate that at least one inhibitor selected from the group consisting of benzoic acid salts, glutamic acid salts, anisidine, glycine, quinolinols, phthalic acid salts, adipic acid salts, and acetic acid salts, when contained in the resin film in a content of from 0.1 to 20 percent by mass, helps to further suppress the contact corrosion of the aluminum sheet.

By contrast, as is indicated in Table 6, the specimen for contact corrosion simulation test in Comparative Example 10 using the steel sheet bearing no resin film, and the specimen for contact corrosion simulation test in Comparative Example 11 using the steel sheet bearing a thin resin film of 0.05 μm suffer contact corrosion in the aluminum sheet in terms of erosion depth of 0.17 mm or more. The specimens for contact corrosion simulation test in Comparative Examples 12 and 13 having the steel sheet bearing a resin film of poly(vinyl butyral) or polyacrylic acid suffer contact corrosion to the same extent as in the specimen in Comparative Example 10 having the steel sheet bearing no resin film.

### INDUSTRIAL APPLICABILITY

The joint structure of steel sheet/aluminum sheet manufactured by the manufacturing method according to the present invention is highly resistant to contact corrosion and is thereby applicable to a wide variety of areas typically of transportation equipment such as automobiles and railway vehicles; machinery; civil engineering, construction, and plants; and electronics.

1. A method for manufacturing a joint structure of a steel sheet and an aluminum sheet, the steel sheet and the aluminum sheet being joined to each other so as to be electrically connected to each other,
the method comprising the step of forming a resin film to a thickness of from 0.1 to 5.0 μm at least on a contact surface of the steel sheet, the resin film including at least one resin selected from the group consisting of polyolefin resins, polyurethane resins, and epoxy resins.

2. The manufacturing method according to claim 1, wherein the resin film comprises a silica in a content of from 5 to 80 percent by mass.

3. The manufacturing method according to claim 1, wherein the resin film comprises at least one inhibitor selected from the group consisting of benzoic acid salts, glutamic acid salts, anisidine, glycine, quinolinols, phthalic acid salts, adipic acid salts, and acetic acid salts in a total content of from 0.1 to 20 percent by mass.

4. The manufacturing method according to claim 1, wherein the step of forming the resin film is performed by wringing with a wringer roll or coating with a roll water.

5. The manufacturing method according to claim 1, wherein the steel sheet is a zinc-plated steel sheet.

6. The manufacturing method according to claim 1, further comprising, after the step of forming the resin film, the step of joining the steel sheet and the aluminum sheet to each other through resistance spot welding.

7. A joint structure of a steel sheet and an aluminum sheet, manufactured by the manufacturing method of claim 1.
